(19) United States
(12) Patent Application Publication
(10) Pub. No.: US 2026/0011809 A1
(43) Pub. Date: Jan. 8, 2026

(54) THERMAL BARRIER ASSEMBLIES FOR TRACTION BATTERY PACKS

(71) Applicant: FORD GLOBAL TECHNOLOGIES, LLC, Dearborn, MI (US)

(72) Inventors: Daryl Arnell Marlow, Dearborn, MI (US); Daniel Paul Roberts, Livonia, MI (US); Francisco Fernandez-Galindo, Canton, MI (US); Alexey Konstantinov, Dearborn, MI (US)

(21) Appl. No.: 18/761,711

(22) Filed: Jul. 2, 2024

(51) Int. Cl. H01M 10/625; H01M 10/658; H01M 50/249

(52) U.S. Cl. CPC H01M 10/625; H01M 10/658; H01M 50/249; H01M 2200/10; H01M 2220/20

(57) ABSTRACT

Thermal barrier assemblies are provided for managing the transfer of thermal energy within traction battery packs. An exemplary thermal barrier assembly may be arranged axially between battery cells of a battery array and may include a thermal suppression container having an outer pouch and a thermal suppression agent releasably contained within the outer pouch, and at least one cell expansion pad located either inside or outside of the outer pouch. The thermal suppression container may be configured to release the thermal suppression agent when a temperature near the outer pouch exceeds a predefined temperature threshold. The thermal suppression agent may capture or trap particles associated with battery vent byproducts, thereby managing or even preventing the transfer of thermal energy to nearby structures. The cell expansion pad may be configured to accommodate batty cell compression and expansion forces.

### TECHNICAL FIELD

This disclosure relates generally to electrified vehicle traction battery packs, and more particularly to thermal barrier assemblies for managing the transfer of thermal energy within battery arrays of traction battery packs.

### BACKGROUND

A high voltage traction battery pack typically powers the electric machines and other electrical loads of an electrified vehicle. The traction battery pack includes a plurality of battery cells and various other battery internal components that support the electric propulsion of the vehicle.

### SUMMARY

A traction battery pack according to an exemplary aspect of the present disclosure includes, among other things, a battery array, and a thermal barrier assembly arranged within the battery array. The thermal barrier assembly includes a thermal suppression container and at least one cell expansion pad located either inside or outside of the thermal suppression container.

In a further non-limiting embodiment of the foregoing traction battery pack, the thermal barrier assembly is arranged to extend between a first subgrouping of battery cells and a second subgrouping of battery cells of the battery array.

In a further non-limiting embodiment of either of the foregoing traction battery packs, the thermal suppression container includes an outer pouch and a thermal suppression agent contained within the outer pouch.

In a further non-limiting embodiment of any of the foregoing traction battery packs, the thermal suppression agent is contained within the outer pouch by at least one heat sealed seam.

In a further non-limiting embodiment of any of the foregoing traction battery packs, a flag seal of the outer pouch extends laterally outward of the at least one heat sealed seam.

In a further non-limiting embodiment of any of the foregoing traction battery packs, the flag seal is arranged to interface with an array top cover or an array bottom cover of an array housing of the battery array.

In a further non-limiting embodiment of any of the foregoing traction battery packs, the outer pouch is configured to melt, rupture, or otherwise deform to release the thermal suppression agent when a temperature near the thermal suppression container exceeds a predefined temperature threshold.

In a further non-limiting embodiment of any of the foregoing traction battery packs, the outer pouch is comprised of a thermoplastic material.

In a further non-limiting embodiment of any of the foregoing traction battery packs, the thermal suppression agent includes a plurality of silica beads.

In a further non-limiting embodiment of any of the foregoing traction battery packs, the at least one cell expansion pad includes a first cell expansion pad and a second cell expansion pad.

In a further non-limiting embodiment of any of the foregoing traction battery packs, the thermal suppression container is sandwiched between the first cell expansion pad and the second cell expansion pad.

In a further non-limiting embodiment of any of the foregoing traction battery packs, the at least one cell expansion pad is positioned inside an outer pouch of the thermal suppression container.

In a further non-limiting embodiment of any of the foregoing traction battery packs, the at least one cell expansion pad is U-shaped.

In a further non-limiting embodiment of any of the foregoing traction battery packs, the at least one cell expansion pad is made of a foam.

A battery array for a traction battery pack according to another exemplary aspect of the present disclosure includes, among other things, a first battery cell, a second battery cell, and a thermal barrier assembly arranged axially between the first battery cell and the second battery cell and configured to limit a transfer of thermal energy between the first battery cell and the second battery cell. The thermal barrier assembly includes a thermal suppression container having an outer pouch and a thermal suppression agent releasably contained within the outer pouch, and at least one cell expansion pad located either inside or outside of the outer pouch.

In a further non-limiting embodiment of the foregoing traction battery pack, the thermal suppression agent includes at least one of solid silica, aerogel, mica, or basalt.

In a further non-limiting embodiment of either of the foregoing traction battery packs, the at least one cell expansion pad includes a first cell expansion pad and a second cell expansion pad.

In a further non-limiting embodiment of any of the foregoing traction battery packs, the thermal suppression container is sandwiched between the first cell expansion pad and the second cell expansion pad.

In a further non-limiting embodiment of any of the foregoing traction battery packs, the at least one cell expansion pad is positioned inside the outer pouch of the thermal suppression container.

In a further non-limiting embodiment of any of the foregoing traction battery packs, the at least one cell expansion pad is a U-shaped foam pad.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle that includes a traction battery pack.

FIG. 2 is a cross-sectional view of select portions of a battery array of a traction battery pack. The battery array includes a thermal barrier assembly that is configured to manage the transfer of thermal energy across the battery array.

FIG. 3 schematically illustrates the behavior of a thermal suppression container of the thermal barrier assembly of FIG. 2 during a battery thermal event.

FIG. 4 illustrates a thermal suppression container of a thermal barrier assembly.

FIG. 5 is a cross-sectional view of the thermal suppression container of FIG. 4.

FIG. 6 illustrates another exemplary thermal barrier assembly for a battery array of a traction battery pack.

### DETAILED DESCRIPTION

This disclosure details thermal barrier assemblies configured for managing the transfer of thermal energy within traction battery packs. An exemplary thermal barrier assembly may be arranged axially between battery cells of a battery array. The thermal barrier assembly may include a thermal suppression container having an outer pouch and a thermal suppression agent releasably contained within the outer pouch, and at least one cell expansion pad located either inside or outside of the outer pouch. The thermal suppression container may be configured to release the thermal suppression agent when a temperature near the outer pouch exceeds a predefined temperature threshold. The thermal suppression agent may capture or trap particles associated with battery vent byproducts, thereby managing or even preventing the transfer of thermal energy to nearby structures. The cell expansion pad may be configured to accommodate batty cell compression and expansion forces. These and other features are discussed in greater detail in the following paragraphs of this detailed description.

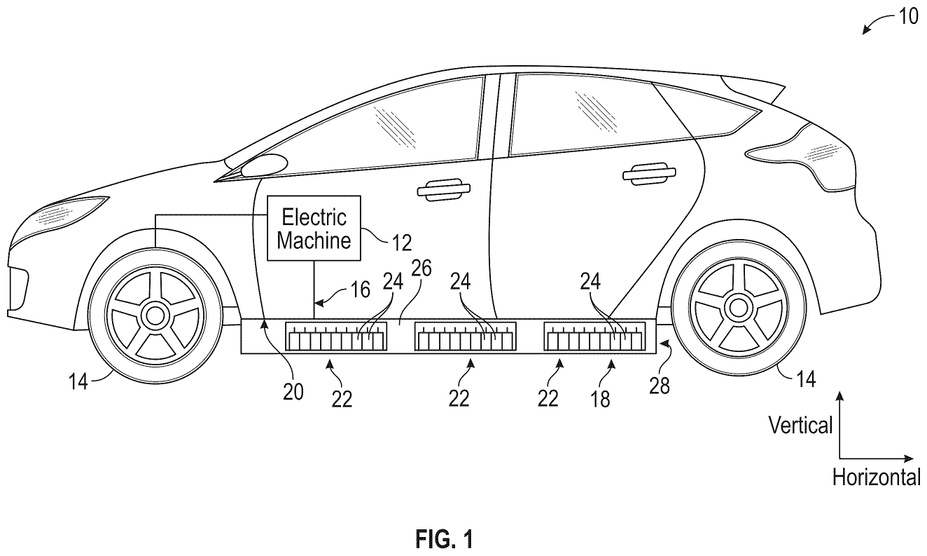

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery modules or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The one or more battery arrays 22 of the traction battery pack 18 may each include a plurality of battery cells 24 that store energy for powering various electrical loads of the electrified vehicle 10. The traction battery pack 18 could employ any number of battery cells 24 within the scope of this disclosure. Accordingly, this disclosure should not be limited to the highly schematic configuration shown in FIG. 1.

In an embodiment, the battery cells 24 of each battery array 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

One or more of the battery cells 24 can periodically release vent byproducts, such as during an overcharge condition, an overdischarging condition, a short circuit, etc. The vent byproducts can be released from the battery cells 24 through a vent. Pressure increases within one of the battery cells 24 can cause the vent to rupture, thereby creating a path for the vent byproducts to be released from inside the battery cell 24. This disclosure is primarily directed to thermal barriers systems designed for managing the transfer of thermal energy when one or more of the battery cells 24 release vent byproducts.

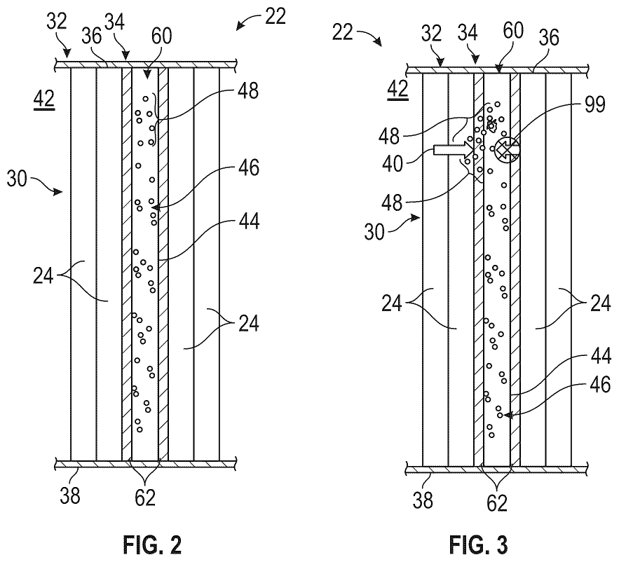

FIGS. 2 and 3 illustrate select portions of a battery array 22 of the traction battery pack 18. As explained in further detail below, the battery array 22 may incorporate features designed for managing the cell-to-cell transfer of thermal energy across the battery array 22.

The battery array 22 may include a plurality of battery cells 24. The total number of battery cells 24 provided within the battery array 22 could vary and is not intended to limit this disclosure. The battery cells 24 may be grouped together in a cell stack 30.

An array housing 32 of the battery array 22 may be arranged to substantially surround the cell stack 30. The array housing 32 may include a top cover 36 and a bottom cover 38. The array housing 32 could further include a pair of side plates and a pair of end plates (not shown for simplicity and clarity). The top cover 36, the bottom cover 38, the pair of side plates, and the pair of end plates may be connected together to establish an interior volume 42 of the battery array 22. The battery cells 24 may be positioned within the interior volume 42.

The battery array 22 may further include one or more thermal barrier assemblies 34 arranged for managing the transfer of thermal energy across the cell stack 30. Each thermal barrier assembly 34 can be strategically positioned within the battery array 22 to establish a cell-to-cell thermal barrier for managing the transfer of thermal energy during battery venting events. For example, among other benefits, the thermal barrier assemblies 34 may be configured to mitigate the cell-to-cell and/or array-to-array transfer of thermal energy when one or more of the battery cells 24 within the cell stack 30 release vent byproducts 40 (schematically shown in FIG. 3) during a thermal event.

Each thermal barrier assembly 34 may be arranged within the interior volume 42 of the battery array 22. In an embodiment, the thermal barrier assemblies 34 are positioned axially between adjacent subgroupings of battery cells 24 of the cell stack 30, with each subgrouping including any desired number of battery cells. However, other arrangements are contemplated within the scope of this disclosure, and it should be understood that the thermal barrier assemblies 34 could be arranged within any void space of the battery array 22 where it is desirable to limit the transfer of thermal energy.

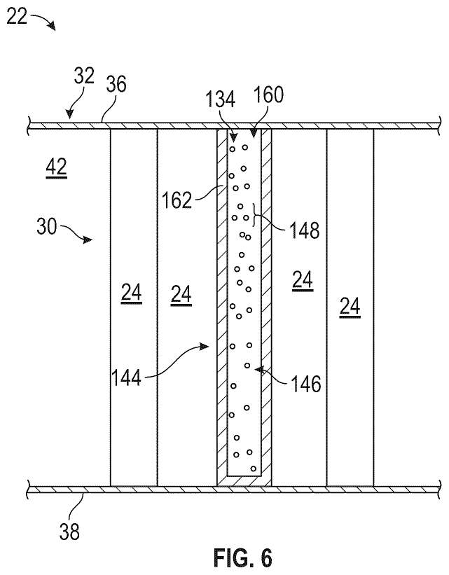

Each thermal barrier assembly 34 may be configured as a multi-layered barrier structure that includes a thermal suppression container 60 and one or more cell expansion pads 62. In an embodiment, the thermal suppression container 60 is sandwiched between a pair of the cell expansion pads 62. The cell expansion pads 62 may therefore be positioned axially between the battery cells 24 and the thermal suppression container 60. However, other configurations are contemplated within the scope of this disclosure (see., e.g., the embodiment of FIG. 6).

Each thermal suppression container 60 may include an outer pouch 44 and a thermal suppression agent 46 contained within the outer pouch 44. The outer pouch 44 may be non-rigid and can thus contort to conform to the thermal suppression agent 46 to prevent shifting during vibration, thereby reducing noise.

The outer pouch 44 may be made of a suitable thermoplastic material. Suitable thermoplastic materials include but are not limited to polypropylene, high density polyethylene, polyethylene terephthalate (PET), plastic laminates, and acrylic based materials. However, the actual material make-up of the outer pouch 44 is not intended to limit this disclosure.

The thermal suppression agent 46 may be held within a hollow interior volume provided by the outer pouch 44. The thermal suppression agent 46 may be made of a high temperature material such as solid silica, aerogel, mica, basalt, etc. In this embodiment, the thermal suppression agent 46 includes a plurality of silica beads 48. However, the thermal suppression agent 46 could alternatively be provided in powder form, for example.

The outer pouch 44 of the thermal suppression container 60 may be configured to melt, rupture or otherwise deform to release the thermal suppression agent 46 when exposed to temperatures that exceed a predefined temperature threshold (e.g., between 150 and 250 degrees Celsius). Such temperatures may be present, for example, when one or more battery cells 24 near the thermal barrier assembly 34 vents and releases the vent byproducts 40. Once released from the outer pouch 44, the silica beads 48 may capture or trap particles associated with the vent byproducts 40, thereby managing or even preventing the transfer of thermal energy toward the non-venting battery cells 24 of the cell stack 30 (schematically illustrated at reference numeral 99 in FIG. 3).

Each cell expansion pad 62 may be adhered to a neighboring battery cell 24, the outer pouch 44 of the thermal suppression container 60, or both. The cell expansion pads 62 of the thermal barrier assembly 34 may each be made of a resiliently flexible or compressible material(s) for accommodating battery cell compression and expansion forces and for preventing indentation of the silica beads 48 into the battery cells 24 that are immediately adjacent to the thermal barrier assembly 34. The resiliently flexible/compressible material may include polyurethane foam or silicone foam, for example. However, other materials or combinations of materials could be utilized to provide the cell expansion pads 62 with flexible properties within the scope of this disclosure.

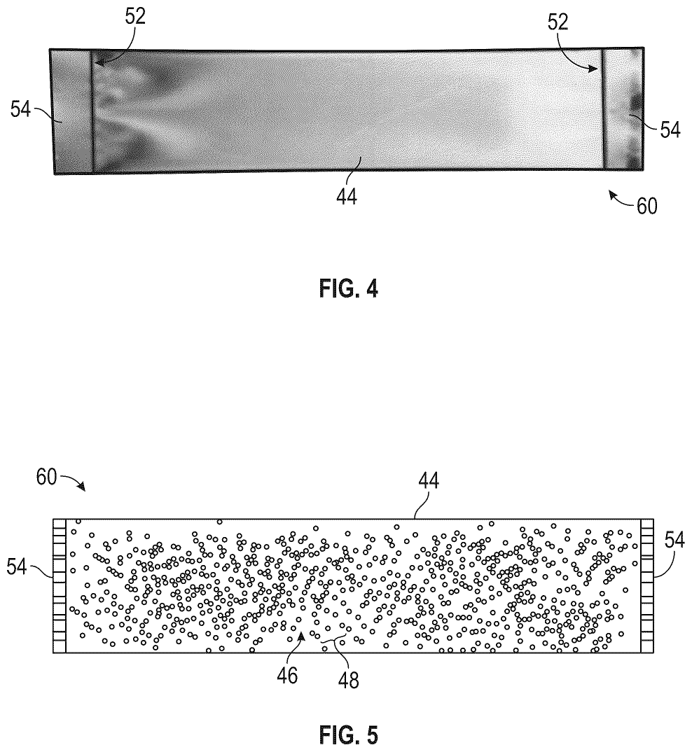

Referring now primarily to FIGS. 4-5 (with continued reference to FIGS. 2-3), the outer pouch 44 of the thermal suppression container 60 may include one or more flag seals 54 that can help maintain a positioning of the thermal barrier assembly 34 relative to the array housing 32. Each flag seal 54 may be established by a heat sealed seam 52 of the outer pouch 44. The heat sealed seams 52 may be formed using a vacuum forming process, for example. The heat sealed seams 52 may contain the thermal suppression agent 46 (see FIG. 5) inside the hollow interior volume provided by the outer pouch 44, thereby providing moisture resistance and preventing deterioration of the silica beads 48 over time.

Each flag seal 54 may extend laterally outward from one of the heat sealed seams 52. Each flag seal 54 may be configured to bend relative to a remaining portion of the outer pouch 44 in order to locate and retain the thermal suppression container 60 relative to the battery cells 24 and the array housing 32 of the battery array 22. The flag seals 54 may therefore accommodate size variations of the thermal suppression containers 60, prevent unwanted movement of the thermal suppression container 60 within the battery array 22, reduce noise, etc.

FIG. 6 illustrates another exemplary thermal barrier assembly 134 that can be arranged to managing the transfer of thermal energy across the cell stack 30 of the battery array 22. The thermal barrier assembly 134 is similar to the thermal barrier assembly 34 discussed above and may include a thermal suppression container 160 and one or more cell expansion pads 162. However, in this implementation, the cell expansion pad 162 may be placed inside an outer pouch 144 of the thermal suppression container 160. The thermal suppression container 160 may thus be positioned immediately adjacent to the battery cells 24 without any intermediate structures in this implementation. Such a positioning can help prevent silica beads 148 of a thermal suppression agent 146 that is contained inside the outer pouch 144 from indenting into the battery cells 24 that flank the thermal barrier assembly 134.

In an embodiment, the cell expansion pad is U-shaped. However, other configurations are contemplated within the scope of this disclosure.

The exemplary thermal barrier assemblies of this disclosure are designed to incorporate dispersible high temperature capable materials for mitigating the transfer of thermal energy across a battery array of a traction battery pack. The systems may provide numerous advantages over known solutions, including but not limited to presenting a novel configuration that significantly slows or even prevents the cell-to-cell transfer of thermal energy, provides better space utilization and packaging efficiency, reduces noise, vibration, and harshness, simplifies installation and packaging, augments cell venting performance, etc.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery array; and
a thermal barrier assembly arranged within the battery array, wherein the thermal barrier assembly includes a thermal suppression container and at least one cell expansion pad located either inside or outside of the thermal suppression container.

2. The traction battery pack as recited in claim 1, wherein the thermal barrier assembly is arranged to extend between a first subgrouping of battery cells and a second subgrouping of battery cells of the battery array.

3. The traction battery pack as recited in claim 1, wherein the thermal suppression container includes an outer pouch and a thermal suppression agent contained within the outer pouch.

4. The traction battery pack as recited in claim 3, wherein the thermal suppression agent is contained within the outer pouch by at least one heat sealed seam.

5. The traction battery pack as recited in claim 4, wherein a flag seal of the outer pouch extends laterally outward of the at least one heat sealed seam.

6. The traction battery pack as recited in claim 5, wherein the flag seal is arranged to interface with an array top cover or an array bottom cover of an array housing of the battery array.

7. The traction battery pack as recited in claim 3, wherein the outer pouch is configured to melt, rupture, or otherwise deform to release the thermal suppression agent when a temperature near the thermal suppression container exceeds a predefined temperature threshold.

8. The traction battery pack as recited in claim 3, wherein the outer pouch is comprised of a thermoplastic material.

9. The traction battery pack as recited in claim 3, wherein the thermal suppression agent includes a plurality of silica beads.

10. The traction battery pack as recited in claim 1, wherein the at least one cell expansion pad includes a first cell expansion pad and a second cell expansion pad.

11. The traction battery pack as recited in claim 10, wherein the thermal suppression container is sandwiched between the first cell expansion pad and the second cell expansion pad.

12. The traction battery pack as recited in claim 1, wherein the at least one cell expansion pad is positioned inside an outer pouch of the thermal suppression container.

13. The traction battery pack as recited in claim 12, wherein the at least one cell expansion pad is U-shaped.

14. The traction battery pack as recited in claim 1, wherein the at least one cell expansion pad is comprised of a foam.

15. A battery array for a traction battery pack, comprising:
a first battery cell;
a second battery cell; and
a thermal barrier assembly arranged axially between the first battery cell and the second battery cell and configured to limit a transfer of thermal energy between the first battery cell and the second battery cell, wherein the thermal barrier assembly includes a thermal suppression container having an outer pouch and a thermal suppression agent releasably contained within the outer pouch, and at least one cell expansion pad located either inside or outside of the outer pouch.

16. The traction battery pack as recited in claim 15, wherein the thermal suppression agent includes at least one of solid silica, aerogel, mica, or basalt.

17. The traction battery pack as recited in claim 15, wherein the at least one cell expansion pad includes a first cell expansion pad and a second cell expansion pad.

18. The traction battery pack as recited in claim 17, wherein the thermal suppression container is sandwiched between the first cell expansion pad and the second cell expansion pad.

19. The traction battery pack as recited in claim 15, wherein the at least one cell expansion pad is positioned inside the outer pouch of the thermal suppression container.

20. The traction battery pack as recited in claim 19, wherein the at least one cell expansion pad is a U-shaped foam pad.
